(19) United States
(12) Patent Application Publication
(10) Pub. No.: US 2026/0274433 A1
(43) Pub. Date: Sep. 17, 2026

(54) JET PROPULSION UTILIZING CRYOGENIC FUEL

(71) Applicant: MFGL Technology LLC, Corpus Christi, TX (US)

(72) Inventor: Preston Henry CARTER

(73) Assignee: MFGL Technology LLC, Corpus Christi, TX (US)

(21) Appl. No.: 18/863,789

(22) PCT Filed: Feb. 2, 2024
(86) PCT No.: PCT/US2024/014161

§ 371 Date: Nov. 7, 2024

Related U.S. Application Data
(60) Provisional application No. 63/496,636, filed on Apr. 17, 2023.

(51) Int. Cl. B64D 37/30; B64D 27/20; B64D 33/08; B64D 37/02; F02C 7/224

(52) U.S. Cl. CPC B64D 37/30; B64D 33/08; B64D 37/02; F02C 7/224

(57) ABSTRACT

An apparatus warms fuel prior to combustion in a jet engine of an aircraft and supplies cooled bleed air to the aircraft. The apparatus includes a fuel flow path configured to supply fuel to the jet engine for combustion, an air flow path including an inlet air conduit configured to receive external freestream ram air, and an inlet air heat exchanger configured to transfer heat from the inlet air conduit to gaseous state fuel in the fuel flow path prior to supply of the fuel to the jet engine. The inlet air conduit is a first air conduit and the air flow path includes a second air conduit that directs cooled air after the inlet air heat exchanger to the aircraft.

### BACKGROUND OF THE INVENTION

Long-range aircraft have many commercial, governmental, and national security applications. The duration of long-range trips increases the desire for higher speed to shorten travel time. To shorten trips to a few hours across intercontinental distances, aircraft speeds must significantly exceed the speed of sound.

Unfortunately, supersonic flight is accompanied by sonic boom. Because of the detrimental effects of sonic booms, supersonic flight is politically and technically restricted from flying over densely populated regions in most cases; therefore, supersonic flights must rely upon largely oceanic routes and upon torturous routes that avoid populated areas. Across intercontinental distances, to maximize fuel economy and minimize flight times it is preferable to fly great-circle routes, which have the shortest point-to-point distance between global destinations. However, for supersonic flight, it is often necessary to fly longer routes to avoid flying over sensitive areas. In a practical sense, supersonic flights are presently restricted to city pairs that can be connected by largely oceanic routes. This route restriction adds to the necessity for supersonic aircraft to have long-range. Flight times may be shorter when routes are flown at higher Mach numbers, but the total range flown is often longer.

### SUMMARY OF THE INVENTION

The present application appreciates that use of cryogenic fuel rather than conventional liquid hydrocarbon jet (HCJ) fuel allows aircraft to have very-long ranges at supersonic speeds. Cryogenic fuel can be defined as fuel stored in a liquid phase at very low temperature for dense storage and as a refrigerant source. The temperature of a cryogenic fuel is below the boiling point and at a storage pressure and temperature at or below its critical point and above its triple point. For permanent gas fuel, temperatures are below 120° K, such as hydrogen at 20° K and methane at 112° K. For a fuel with a more complex molecule, the boiling point is below the ambient temperature of the application and cold enough to provide desired phase change and latent heat cooling. For such a cryogenic fuel, a boiling point below 235° K is assumed, such as propane at 231° K.

The present application presents propulsive heating and cooling (PHC) techniques that increase the practicality of utilizing cryogenic fuel for high-speed aircraft. In the following description, use of cryogenic fuel is discussed with reference to one specific non-limiting example of cryogenic hydrogen fuel. However, it should be appreciated that the described techniques are also applicable to other cryogenic fuel types (e.g., cryogenic propane or cryogenic methane), as discussed further herein.

The disclosed inventions can be employed for marine propulsion. In some embodiments, a high volume of water is slightly cooled to vaporize and heat the cryogenic fuel. As in the aviation application, the cryogenic fuel is preferably vaporized and heated prior to combustion. The use of cooled air for engine and/or other cooling can also be employed in marine propulsion applications.

The disclosed PHC techniques additionally support the extraction of auxiliary power from the heating/expansion of the cryogenic fuel. Auxiliary power encompasses various forms of power, such as electrical power, hydraulic power, and/or pneumatic power.

In the prior art, only a few experimental or specialized aircraft have been adapted to utilize cryogenic fuel. Conceptually, all such aircraft require the fuel to be vaporized before combustion. Conceptually, the heat for vaporization can be obtained from the atmosphere and applied to the fuel by a heat exchanger. The earliest demonstration of a liquid hydrogen-fueled aircraft was a modified Martin B-57B airplane developed by NACA Lewis Laboratory in 1957. In this earliest example, liquid hydrogen pressurized with helium was stored in a wingtip tank. Hydrogen was only heated enough to achieve a gaseous state. A heat exchanger utilizing ram air inflight was used to heat and gasify the liquid hydrogen prior to supply to the engine fuel system.

In some embodiments, a propulsion or power system incorporating the PHC techniques disclosed herein similarly utilizes inflight ram air as the heat source for heating a cryogenic fuel. In some embodiments, a propulsion or power system can alternatively or additionally use compressed air for heating and vaporizing a cryogenic fuel. The PHC techniques can take advantage of heat exchange opportunities between fuel and air to condition both the fuel and air to service the engine and airframe. Additionally, the PHC techniques can utilize heat exchange between fuel and air to drive thermodynamic power cycles in support of PHC operations to provide fuel pressure and to compress bleed air for the engine and airframe.

In the context of conventional turbomachinery, a precooling process can be utilized to cool and densify air entering the turbocompressor. Precooling is common to many applications ranging from power plants to jet aircraft. The most conventional and practical precooling techniques involve evaporative cooling through injection of a small percentage of a coolant, such as water, in the air flow. This coolant injection approach has been used by power plants to maintain power during hot operating conditions and by aircraft to increase thrust for hot day takeoff conditions or for high acceleration at high Mach number. In aircraft applications utilizing cryogenic fuel, cryogenic fluid can be used to cool and densify the inlet air of the engine with an inlet fuel heat exchanger directly in the inlet air flow. Densification of air reduces work required to compress the air, increases air flow mass, and allows the engine to be physically smaller. The cooled air also helps to protect the engine from high temperatures. Precooled hydrogen turbojet engines have been studied extensively, but cryogenic precooling for aircraft has yet to be proven practical or feasible due to durability limitations of inlet fuel heat exchangers and design penalties resulting from the size and weight of the heat exchanger.

Unlike the precooling prior art, the disclosed PHC techniques do not focus exclusively upon the cooling and densification of an engine's working fluid, that is, air. For example, the disclosed PHC techniques support the collection, by any practical means, of freestream air for warming the cryogenic fuel for providing cooled bleed air (not bulk working fluid air) to the engine.

In higher performance turbomachinery, bleed air is used for its capacity to cool engine components or other components of the application environment. If the bleed air temperature becomes too high, its cooling capacity is undesirably reduced. A prior art technique called Cooling Cooled Air (CCA) cools bleed air with liquid hydrocarbon jet fuel (not cryogenic fuel) in an heat exchanger to increase the cooling capacity of the bleed air. Since prior art turbine nozzles and turbine blades are often cooled with bleed air, CCA can be used to allow the engine to operate at higher temperatures and pressures if there is sufficient cooling capacity in the bleed air. CCA is limited, however, by the cooling capacity of liquid hydrocarbon jet fuel. Jet fuel has a modest heat capacity as a coolant and has a flash point about 339° K, after which thermal stability considerations generally limit usage to 567° K, depending upon the application and jet fuel type and composition.

The disclosed PHC techniques can be utilized to increase the cooling capacity of bleed air for the engine and its application environment; however, the disclosed PHC techniques can also be utilized to provide bleed air to the engine so that the engine does not need to collect or produce bleed air. One of the benefits of the disclosed PHC techniques is the conditioning of bleed air provided to the engine and its application environment. In conditioning the bleed air, the disclosed PHC techniques pressurize and cool the bleed air to meet the cooling capacity required by the engine and its application environment utilizing heat exchange with cryogenic fuel. Cryogenic fuels, such as hydrogen, have extraordinary heat capacity far in excess of conventional CCA and are stable to temperatures on scale with combustion temperatures.

In the prior art, thermodynamic cycles that include the cryogenic liquid pressurization (referred to herein as pumping), vaporization, and power extraction by expansion are often referred to as “expander cycles.” Expander cycles are common in rocket engine applications utilizing cryogenic fuels. In the context of rocket propulsion, an expander cycle was first employed in connection with the development of the Centaur liquid hydrogen and liquid oxygen powered rocket in the mid-1950s. The application of the expander cycle to liquid hydrogen powered aircraft was first proposed in 1954 by Randolph Samuel Rae. These expander cycle aircraft used liquid hydrogen fuel in an expander cycle to power a turbofan and combusted the hydrogen to provide jet propulsion. In prior art rocket and aircraft applications, expander cycles act upon the primary working fluid utilized for propulsion. In contrast, in some embodiments, the PHC techniques disclosed herein utilize an expander cycle to power the pumps, compressors, and auxiliary equipment rather than propulsion engine.

In one or more embodiments, an apparatus warms fuel prior to combustion in a jet engine of an aircraft and supplies cooled bleed air to the aircraft (e.g., jet engine(s) and auxiliary off-engine equipment). The apparatus includes a fuel flow path configured to supply fuel to the jet engine for combustion, an air flow path including an inlet air conduit configured to receive external freestream ram air, and an inlet air heat exchanger configured to transfer heat from the inlet air conduit to gaseous state fuel in the fuel flow path prior to supply of the fuel to the jet engine. The inlet air conduit is a first air conduit and the air flow path includes a second air conduit that directs cooled air after the inlet air heat exchanger to the aircraft.

In some embodiments, the fuel flow path includes a bypass conduit through which fuel in the fuel flow path can bypass the inlet air heat exchanger and a control valve configured to selectively control a fraction of the fuel supplied to the jet engine that is permitted to pass through the bypass conduit and bypass the inlet air heat exchanger.

In some embodiments, the apparatus further comprises at least one compressor that compresses the inlet air following heat transfer in the inlet air heat exchanger to obtain cooled and pressurized air supplied by the air flow path to the aircraft. In some embodiments, the at least one compressor produces at least two pressurized air supplies of differing pressures that are supplied to the jet engine.

In some embodiments, the apparatus includes a fuel heat exchanger in the fuel flow path before the inlet air heat exchanger that is configured to transfer heat from the cooled and pressurized air to the fuel in the fuel flow path. In some embodiments, the apparatus includes a control valve configured to selectively control a fraction of the fuel in the fuel flow path that is permitted to pass through the fuel heat exchanger.

In some embodiments, the apparatus includes at least one expander driven by expansion of the fuel and a drive shaft coupled to the expander. In some embodiments, the apparatus includes a fuel pump driven by the drive shaft to pump the fuel into the fuel flow path. In some embodiments, the apparatus includes multiple expanders and a valve controlling a fraction of the fuel passing through one of the expanders.

In some embodiments, the apparatus includes an auxiliary powered device driven by the shaft. In some embodiments, the apparatus includes a compressor coupled to a shaft, where the compressor is configured to compress the inlet air following heat transfer in the inlet air heat exchanger to obtain pressurized air supplied to the aircraft.

In some embodiments, the apparatus includes a body heat exchanger configured to transfer heat from a body cooling loop of the aircraft to the air flow path.

In some embodiments, the apparatus includes a power shaft, a compressor coupled to the power shaft and configured to compress the inlet air to obtain pressurized air supplied to the aircraft, and a expander coupled to power the power shaft and driven by expansion of the fuel in the fuel flow path. The work performed by the expander is at least equal to the work performed by the compressor.

In some embodiments, the apparatus forms a portion of an aircraft including an airframe, a wing assembly coupled to the airframe, at least one jet engine coupled to the airframe, a fuel tank configured to hold cryogenic fuel in a liquid state, and a fuel pump coupled to the fuel tank. The apparatus can be coupled by the fuel flow path to the fuel pump and the air flow path to the jet engine.

### BRIEF DESCRIPTION OF THE DRAWINGS

FIG. 1 is a graph of lift-to-drag ratio versus cruise Mach number for supersonic aircraft;

FIG. 2 is a graph of propulsion of specific impulse versus Mach number for supersonic aircraft;

FIG. 3 is a graph of aircraft range capability versus Mach number for supersonic aircraft;

FIG. 4 is a graph of adiabatic flame temperature as a function of the fuel/air equivalence ratio for hydrogen and other fuels at standard temperature and pressure;

FIG. 5 is a graph of adiabatic flame temperature as a function of the fuel/air equivalence ratio for various fuel injection temperatures;

FIG. 6 is a graph of the stagnation temperatures and dynamic pressures that are possible for aircraft as a function of Mach number and altitude;

FIG. 7 is a graph of stagnation heating flux as a function of Mach number and flight altitude;

FIG. 8 is a graph of specific impulse versus Mach number and fuel temperature for supersonic aircraft;

FIG. 9 is a graph of aircraft range versus Mach number for heated and unheated fuel;

FIG. 10A is a side elevation view of an exemplary supersonic aircraft in accordance with one or more embodiments;

FIG. 10B is a bottom plan view of an exemplary supersonic aircraft in accordance with one or more embodiments;

FIG. 11 is a section view of an exemplary turboramjet engine in accordance with one or more embodiments;

FIG. 12 is an exemplary propulsive heating and cooling (PHC) system in accordance with one or more embodiments;

FIG. 13 is a Pressure-Volume (P-V) thermodynamic chart of an air flow path of an exemplary PHC system; and

FIG. 14 is a P-V chart of a fuel flow path of an exemplary PHC system.

In accordance with common practice, various features illustrated in the drawings may not be drawn to scale. Accordingly, dimensions of the various features may be arbitrarily expanded or reduced for clarity. In addition, some of the drawings may not depict all of the components of a given system, method, or device. Finally, like reference numerals may be used to denote like or corresponding features in the specification and figures.

### DETAILED DESCRIPTION OF ILLUSTRATIVE EMBODIMENT

The range performance of current aircraft, fueled with liquid hydrocarbon jet (HCJ) fuel, decreases with increasing Mach number. Aircraft range can be estimated with the Breguet range equation:

$$Range = L / D {I}_{s p} V ln ( \frac{1}{P F + M F} ) \qquad [ Eq . 1 ]$$

$$where : L / D is the vehicle cruise lift to drag ratio ,$$

$${I}_{sp} is the specific impulse during cruise ,$$

$$V is the velocity of cruising flight ,$$

$$MF is the empty mass fraction of the vehicle ; that is ,$$

$$the ratio of the empty mass over the gross take off mass ( GTOM ) ,$$

$$PF is the payload fraction of the vehicle computed$$

$$as the ratio of the payload mass over the GTOM .$$

Required payload fraction PF is driven by the business case or mission need of the aircraft. Generally, for long-range aircraft a payload fraction greater than 5% is desired. Empty mass fraction MF is technology-driven. The typical state-of-the-art long-range aircraft has a value of MF between 40% and 50%. If the logarithmic term of the Breguet range equation (i.e., ln

$$( \frac{1}{P F + M F} ) )$$

is assumed constant, it is seen that the lift-to-drag ratio L/D, specific impulse Iₛₚ, and cruise velocity V are the primary design parameters that determine an aircraft's range.

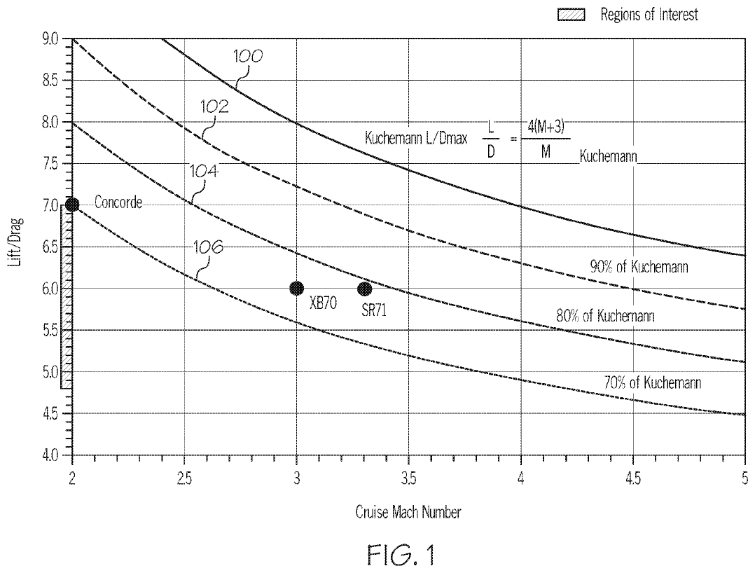

With reference now to FIG. 1, there is illustrated a graph of lift-to-drag ratio (L/D) versus cruise Mach number for state-of-the-art supersonic aerodynamic designs. As can be seen in FIG. 1, in accordance with the Kuchemann L/Dₘₐₓ formula, the quantity L/Dₘₐₓ, which is represented by curve 100, degrades with Mach number. Additional curves 102, 104, and 106 respectively represent L/D values that are 90%, 80%, and 70% of L/Dₘₐₓ. Modern supersonic aircraft designs have not achieved the theoretical L/Dₘₐₓ represented by curve 100; instead, modern supersonic aircraft (e.g., Concorde, XB-70, SR-71) exhibit L/D values that are approximately 75% to 90% of the L/Dₘₐₓ figure estimated by the Kuchemann L/Dₘₐₓ model represented by curve 100.

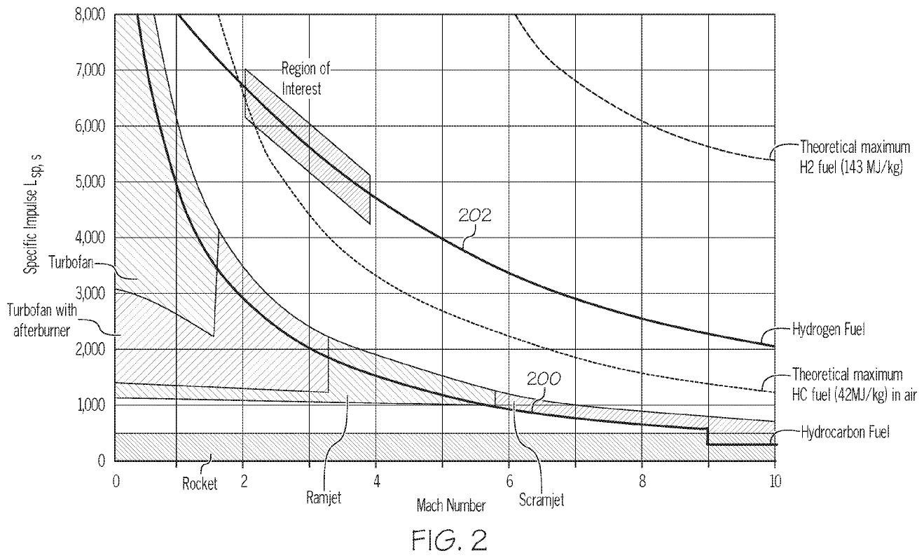

State-of-the-art specific impulse (Iₛₚ) values for jet propulsion are represented in FIG. 2 in a similar manner. Specifically, FIG. 2 depicts a graph of typical Iₛₚ values versus Mach number for HCJ-fueled aircraft (see, e.g., curve 200) and hydrogen-fueled aircraft (see, e.g., curve 202) for various types of propulsion systems (e.g., turbofan, turbofan with afterburner, ramjet, scramjet, and rocket). In accordance with FIG. 2, achievable Iₛₚ, regardless of fuel type, degrades with Mach number. FIG. 2 additionally illustrates that hydrogen propulsion systems achieve a higher Iₛₚ than HCJ-fueled systems. It should also be observed that the rate at which Iₛₚ falls with increasing Mach number is lower for hydrogen-fueled aircraft than for HCJ-fueled aircraft.

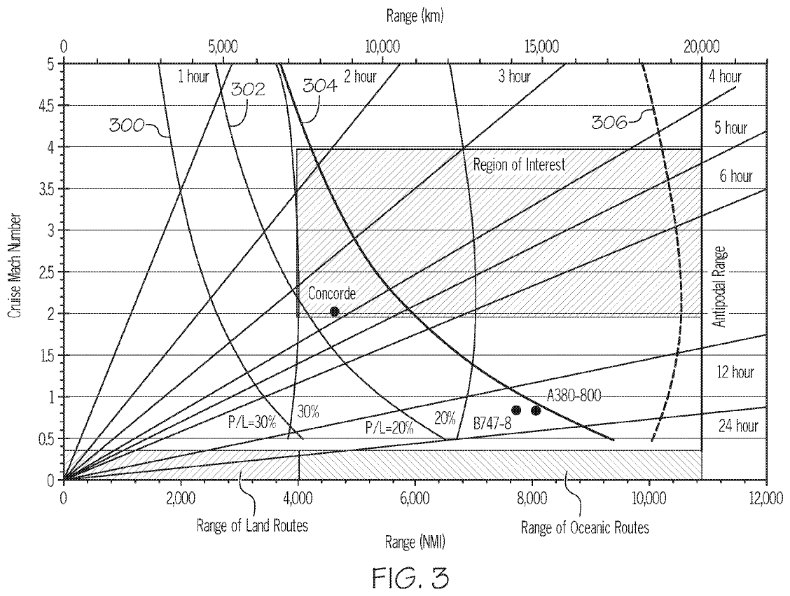

According to the Breguet range equation given as Equation 1, a higher cruise velocity will increase performance kinematically. Unfortunately, both L/D and Iₛₚ parameters degrade with velocity; Consequently, the kinematic benefit of velocity does not materialize, in a noticeable manner, in long-range, high-speed aircraft. With reference now to FIG. 3, there is illustrated a graph of cruise Mach number range versus range capability for HCJ-fueled and hydrogen-fueled aircraft. Aircraft payload/gross takeoff mass (GTOM) ratios of 30%, 20%, and 10% are represented by curves 300, 302, and 304, respectively.

As shown, the range of conventional HCJ-fueled aircraft (e.g., Concorde, Boeing 747-8, Airbus A380-800) degrades with Mach number. It should be noted, however, by reference to curve 306, that the range of hydrogen-fueled aircraft is relatively invariant to Mach number. Hydrogen-fueled aircraft are not as penalized by velocity as HCJ-fueled aircraft because hydrogen propulsion does not lose Iₛₚ as rapidly with Mach number as hydrocarbon propulsion. This attribute allows the kinematic benefit of velocity to contribute towards improved range at high-speed.

Hydrogen-fueled jet aircraft can fly significantly faster and farther than current state-of-the-art HCJ-fueled aircraft. The propulsive heating and cooling (PHC) techniques described herein contribute to the practical use of hydrogen (and other cryogenic) fuels for high-speed, long-range aircraft.

Four major challenges in achieving long-range, high-speed, flight are:
1. Lowering fuel consumption,
2. Managing the heat load and temperatures presented to the engine and airframe from aerothermal heating resulting from air compressibility and friction at supersonic speeds,
3. Minimizing the empty weight of the aircraft, and
4. Achieving a high L/D ratio at high Mach number cruising speed.

The PHC techniques disclosed herein directly address the first two challenges and have an indirect favorable impact upon the third challenge.

### Lowering Fuel Consumption

The current state-of-the-art in propulsion for high-speed flight includes several jet engine types that are suitable for supersonic flight. Suitable engine types include turbojet, turbofan, ramjet, scramjet, pulse detonation, and multi-cycle combinations of these engine types. For all these engine types there are three methods for lowering fuel consumption: 1) selecting a fuel with a higher heat of combustion (ΔH_{c}), 2) selecting a fuel able to support lean fuel-air mixtures in combustion, and 3) adding energy to the fuel-air mixture in the engine combustor. Selecting a fuel with a higher heat of combustion requires less fuel to supply the same energy. Lean mixtures enable lower fuel consumption. The ability to sustain combustion with lean fuel-air mixtures also enables scaling engines to have higher air flow. High-altitude is required for high-speed flight to reduce drag and to reduce aerothermal heating. Larger engines at high-altitude require leaner fuel-air mixtures. Leaner fuel-air mixtures can be beneficial for range performance, but often approach combustor flameout limits for the engine. A larger engine provides for faster acceleration to cruise altitudes, which also reduces overall mission fuel consumption. It is desirable to have a larger engine for faster acceleration and climb, but engine size is limited by the requirement that fuel-air mixtures remain combustible at cruise conditions. A fuel and engine combination that allows for low equivalence ratio (lean) fuel-air mixtures generally reduces fuel consumption. Table I below illustrates several fuels suitable for aviation.

TABLE I

| | | | | | | | Heat | | | | |
|---|---|---|---|---|---|---|---|---|---|---|---|
| | | | | | | | Capacity | Fuel | | | |
| | | Boiling | Crit. | Crit. | Storage | Heat of | (Cₚ) | Air | AR_{stoch} | Lower | ~ER |
| | Storage | Point | Temp. | Press. | Density | Vap. | kJ/(kg | ΔH_{c} | by | Flame | Lower |
| Fuel | State | ° K. | ° K. | MPa | Kg/m3 | kJ/(kg) | ° K.) | MJ/kg | mass | Limit | Limit |
| Hydrogen | Cryogenic | 20.3 | 33.1 | 1.30 | 71 | 447 | 14.3 | 141.6 | 34.3 | 4% | 0.1 |
| Methane | Cryogenic | 111 | 190.6 | 4.60 | 428 | 511 | 2.22 | 55.53 | 17.19 | 5% | 0.5 |
| Propane | Pressurized Gas | 231 | 369.9 | 4.25 | 507 | 428 | 1.67 | 50.33 | 15.67 | 2.1% | 0.5 |
| Rep. HCJ | Liquid | 449 | N/A | N/A | 775 | 300 | 2 | 47.87 | 14.5 | 0.6% | 0.2 |
| Fuel | | | | | | | | | | | |

Heating fuel before combustion adds energy to the propulsion cycle. All engine types require air, once compressed, to be heated to a high temperature through fuel-air combustion before expansion to perform its propulsive work. The adiabatic flame temperature achieved during the combustion of a fuel-air mixture in the combustion chamber is a method to correlate fuel consumption to the level of heat injected into the engine.

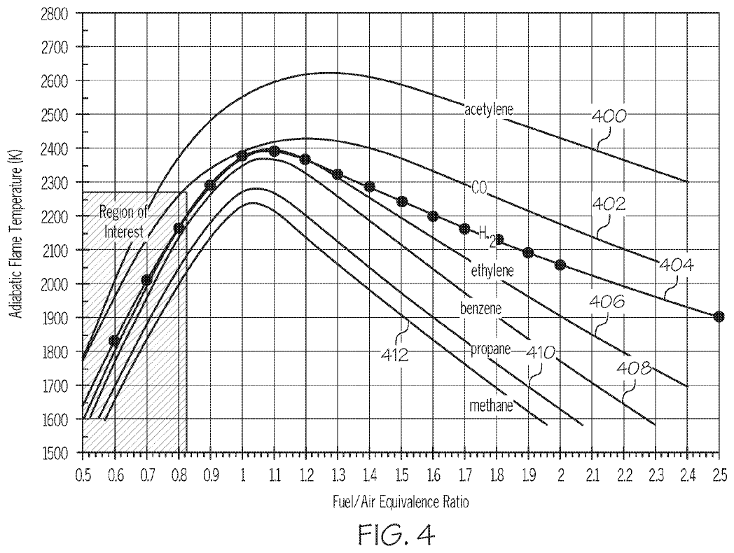

Referring now to FIG. 4, there is depicted a graph of adiabatic flame temperature as a function of the fuel/air equivalence ratio for a variety of aviation fuels at standard temperature and pressure (STP) conditions (i.e., 20° C. and 1 atm). Specifically, FIG. 4 illustrates the adiabatic flame temperature for acetylene, carbon monoxide, hydrogen, ethylene, benzene, propane, and methane with curves 400, 402, 404, 406, 408, 410, and 412, respectively.

Lean fuel/air ratios are represented by an equivalence ratio less than one. In practical applications, the fuel and air components of combustion are rarely at the STP conditions represented in FIG. 4. This data can be approximated for non-standard conditions by evaluating the thermodynamic heat balance of the burner in accordance with Equation 2:

$$Δ {Heat}_{Combustion from STP} = Δ {Heat}_{Air from STP} + Δ {Heat}_{Fuel from STP} ( 1 + \frac{E R}{A R} ) {C}_{p - prods} ( {T}_{adb} - {T}_{adb - S T P} ) = {C}_{p - a i r} ( {T}_{a i r} - {T}_{S T P} ) + \frac{E R}{A R} {C}_{p - f u e l} ( {T}_{f u e l} - {T}_{STP} ) \qquad [ Eq . 2 ]$$

$$where : AR is the stoichiometric Air / Fuel ratio ,$$

$${C}_{p - pair} is specific heat of air under constant pressure ,$$

$${C}_{p - fuel} is specific heat of the fuel under constant pressure ,$$

$${C}_{p - prods} is specific heat of the combustion$$

$$product under constant pressure ,$$

$$ER is the fuel / air equivalence ratio is the ratio of the fuel - to - oxidizer$$

$$ratio to the stoichiometric fuel - to - oxidizer ratio ,$$

$${T}_{a d b - S T P} is adiabatic flame temperature with fuel and air at STP ,$$

$${T}_{a db - non STP} is adiabatic flame temperature with fuel and air not at STP ,$$

$${T}_{a i r} is air temperature supplied to combustion ,$$

$${T}_{fuel} is fuel temperature supplied to compustion ,$$

$${T}_{S T P} is STP temperature .$$

$$Equation 2 can be solved for {T}_{a db - non STP} to obtain Equation 3 :$$

$${T}_{adb - non STP} = {T}_{adb - S T P} + [ \frac{{C}_{p - a i r}}{{C}_{p - prods}} ] ( {T}_{a i r} - 288.15 ° K ) + \frac{E R}{A R} [ \frac{{C}_{p - f u e l}}{{C}_{p - p r o d s}} ] ( {T}_{f u e l} - 288.15 ° K ) \qquad [ Eq . 3 ]$$

T_{adb-STP} and AR are known from experimental data (see, e.g., FIG. 4), and T_{STP} is a defined constant. All specific heats for air, fuel, and products of combustion are known or can be closely approximated. ER is the independent variable that can be used to select a desired T_{adb-non STP}. The temperature of the air into the mixture is determined by the engine cycle and flight conditions, and the ratio of specific heats of air and combustion product is close to one:

$$[ {C}_{p - a i r} / {C}_{p - prods} ] ∼ 1$$

Therefore, little control in the combustion temperature is available in the air term of Equation 3.

The ratio of specific heat for fuel and combustion product, on the other hand is much greater than 1:

$$[ {C}_{p - fuel} / {C}_{p - prods} ] > 1 .$$

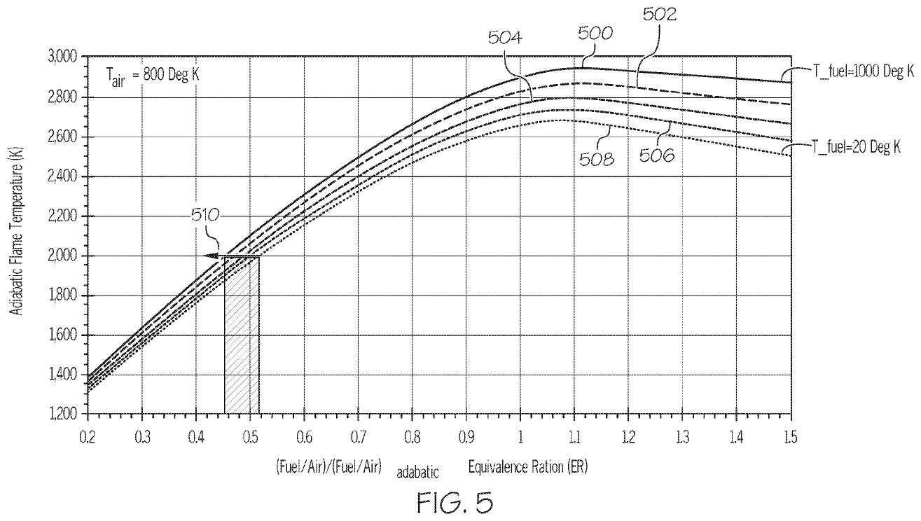

The specific heat of various fuels is compiled in Table I, above. For any given fuel/air equivalence ratio, the adiabatic flame temperature of the burner can be adjusted by changing injected fuel temperature. If the fuel temperature is higher, ER can be decreased to maintain the same flame temperature. FIG. 5 is a graph illustrating the variation of adiabatic flame temperature with fuel/air equivalence ratio for a variety of fuel temperatures, given a Tₐᵢᵣ of 800° K. Specifically, curves 500 to 508 respectively illustrate the relationship between adiabatic flame temperature and fuel/air equivalence ratio for 1000° K, 750° K, 500° K, 293° K, and 20° K, respectively. As shown, utilizing a fuel with a high specific heat adds more heat to the combustion process, resulting in lower fuel consumption. Further, as indicated by arrow 510, with a higher T_{fuel}, the same T_{adaibatic} can be achieved with a lower ER.

### Managing Heat Load and Temperatures

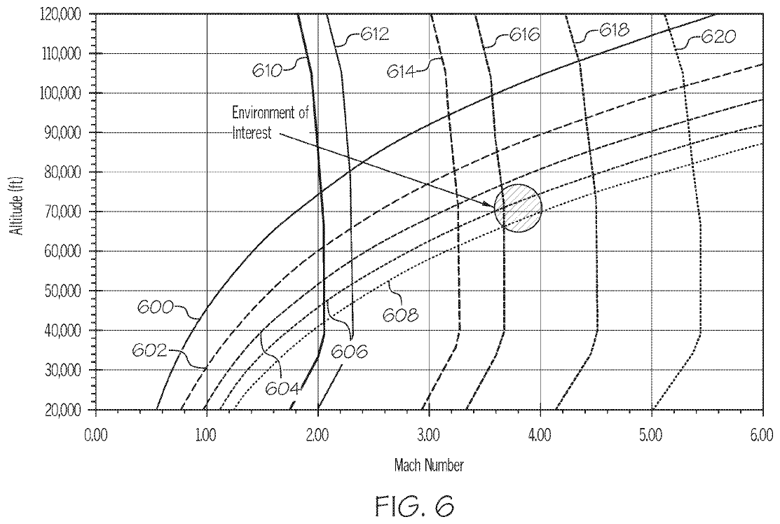

At high-speed, aircraft are subjected to elevated temperatures and heating rates from compression of air, and friction that thermally challenges materials of the engine and airframe. FIG. 6 depicts dynamic pressures that are possible for aircraft as a function of altitude and Mach number. For example, curves 600 to 608 illustrate dynamic pressures for 10 kPa, 20 kPa, 30 KPa, 40 KPa, and 50 KPa, respectively. FIG. 6 additionally illustrates isolines of the practical working temperatures of various common materials used in aircraft design. In this sampling, isolines 610 to 620 represent temperatures of 400° K (the working temperature for aluminum), 450° K (the working temperature for representative composite materials), 680° K (the working temperature for titanium), 800° K (the working temperature for steel), 1,100° K (the working temperature for Inconel), and 1,500° K, respectively. Lighter materials such as aluminum, titanium, and composites are desirable to achieve a lighter airframe. However, higher Mach number flight requires high temperature materials, isolation, and cooling to utilize lighter and/or low-temperature materials.

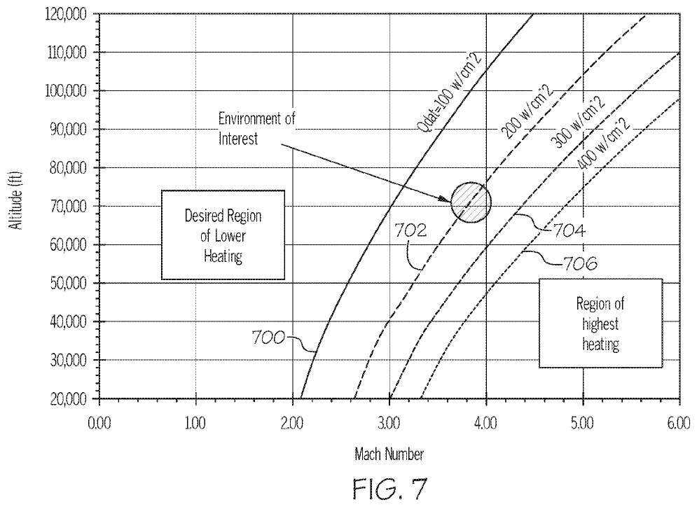

Heating rates upon an aircraft are strongly influenced by the air density (and thus altitude of flight) and velocity of flight. FIG. 7 is a graph illustrating the stagnation heating flux upon a 10 cm radius sphere exposed to various altitude and Mach number flight conditions. In FIG. 7, curves 700 to 706 represent sample stagnation heating fluxes of 100 W/cm², 200 W/cm², 300 W/cm², and 400 W/cm², respectively. As can be seen, to avoid higher heating rates, aircraft are potentially constrained to fly at higher altitudes or slower speeds or both.

Challenges of high temperatures and high heating rates can be met using several strategies. Heat transfer to the aircraft from the flight environment is limited by methods of heat reflection, re-radiation, and insulation of the aerodynamic surfaces; however, some level of heat absorption by radiative, conductive, and convective methods is unavoidable. Absorbed heat conducted into the airframe increases the temperature of the airframe, which can challenge the performance of the airframe's structure and the operating tolerance of the payload and systems of the aircraft. Some portions of the aircraft can safely get hot because the materials and associated technology are tolerant of the presented thermal environment. Airframe or propulsion hot sections are examples of thermally tolerant portions of an aircraft. More thermally-sensitive portions of the aircraft can be required to be maintained within necessary thermal bounds. Payload, avionics, and control actuators are example of more thermally-sensitive portions of a vehicle. Design methods to maintain a thermal environment include both passive and active cooling strategies. In many cases, actively cooling a region must be employed to transfer and to dissipate heat from the aircraft. In accordance with some of the disclosed embodiments, fuel can be used to adsorb heat from the aircraft for thermal control.

### Minimizing Empty Weight of Aircraft

As has been described, reducing the empty mass fraction of an airplane improves range performance. High-speed flight places structural and thermal loads upon the airframe that can potentially necessitate designs having an increased empty mass fraction. The structural airframe is the largest portion of the empty weight of an aircraft. With challenging thermal conditions, aircraft designers make choices between strategies that allow the structural airframe to become hot, strategies that insulate and protect the structural airframe from heat, and strategies that cool the structural airframe. Higher temperatures usually require materials that have higher density or structural designs that use light material with additional bulk to address design loads. Cooled structures can utilize the lightest/strongest materials, but additional weight and complexity may be required to provide necessary cooling. Cooled structures can often provide the lightest weight design if enough cooling capacity is available. Greater cooling capacity allows the design of lighter vehicles.

### Solutions

The PHC techniques presented in this application vaporize and heat cryogenic fuel for jet propulsion. The PHC techniques are applicable to any jet engine type, for example, turbojet, turbofan, ramjet, turboramjet, scramjet, and pulse-detonation jet engines, as well as expander turbine and multi-cycle combinations of jet engines. In the following discussion, the PHC techniques are described with reference to an exemplary turboramjet engine.

While the PHC techniques are applicable to any cryogenic fuel, the described embodiment assumes liquid hydrogen as the cryogenic fuel for ease of explication. Hydrogen fuel can fundamentally enable long-range flight at high Mach numbers because of its exceptionally high heat of combustion and achievable lean mixtures. Hydrogen is cryogenically cooled to a liquid to increase its storage density. The disclosed PHC techniques take advantage of liquid hydrogen as a source of cooling for the engines and airframe made hot by aerothermal heating at high Mach numbers. The latent heat of vaporization and the heat capacity of hydrogen, as it is heated from a liquid to combustion injection conditions, provide a tremendous resource for heat absorption and for performing useful work for the engine and airframe.

The disclosed PHC techniques include the pressurization and heating of fuel for injection into the engine. Benefits of combustion are greatly increased by heating the fuel prior to burning. External heat to vaporize and heat the fuel is preferably harvested from inlet air. This inlet air is compressed and warmed by flight stagnation conditions. It is assumed there is an excess of external heat available for fuel heating due to the nature of the high-speed flight. The cooling of this external air can provide the heat for powering the system.

After the cryogenic fuel has been vaporized and heated to some determined temperature with inlet air, the fuel (which is likely non-cryogenic at this point due to the vaporization and heating) is used as a working fluid in a power cycle to supply power to mechanical elements of the system and to provide auxiliary power to the engine and airframe. Generating power in this manner has the added benefit of disposing of some of the heat already deposited in the fuel, allowing the fuel to provide more cooling capacity to the airframe and engine before the heated fuel is delivered to the engine for combustion. Heat added to the fuel increases the latent energy in the fuel-air mixture for combustion resulting in higher heating value to the engine cycle. This improved combustion heating value results in reduced fuel consumption throughout the flight profile.

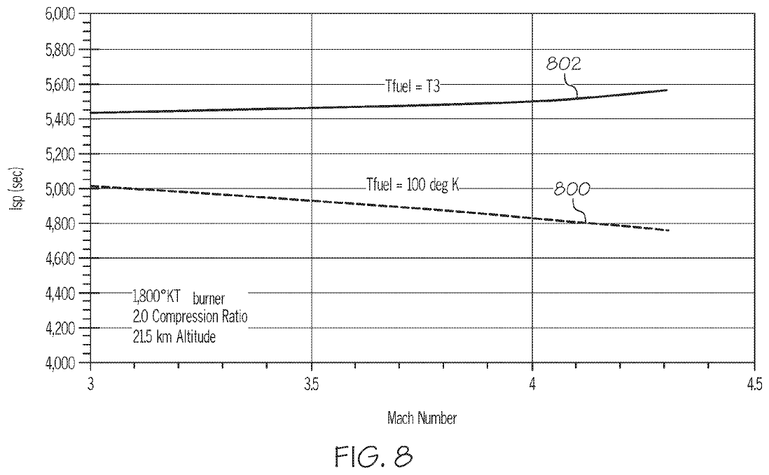

Referring now to FIG. 8, there is depicted a graph of specific impulse Iₛₚ versus Mach number, assuming combustion conditions including a 1,500° K burner temperature, a 2.0 compression ratio, and 21.5 km flight altitude. As shown, specific impulse Iₛₚ is dependent on the fuel temperature prior to combustion. For example, curve 800 depicts specific impulse Iₛₚ for a T_{fuel} of 100° K, while curve 802 depicts specific impulse Iₛₚ for a T_{fuel} of engine compressor exit temperature T₃, which can near 1000° K at high Mach number flight conditions. In accordance with some embodiments, the disclosed PHC techniques can heat the fuel prior to combustion to near T₃ temperatures. Heating the fuel improves specific impulse Iₛₚ, which directly improves the aircraft range in accordance with Equation 1.

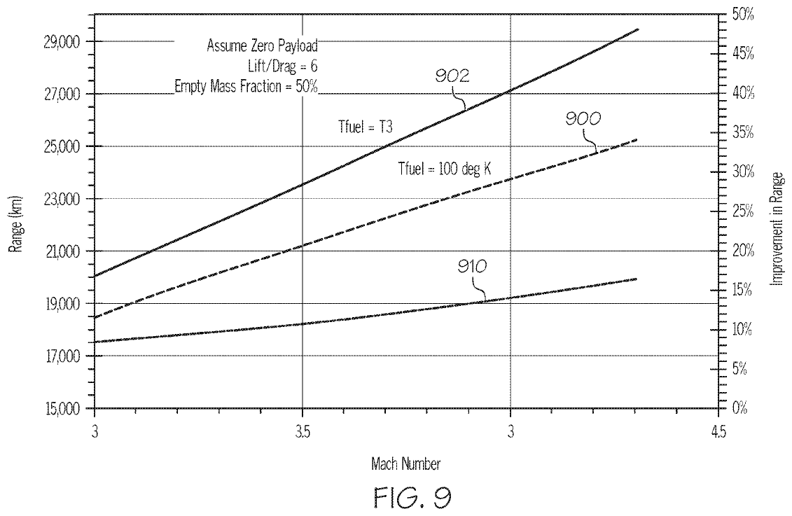

To illustrate the possible range improvement, FIG. 9 provides a graph illustrating exemplary aircraft range and range improvements at flight speeds over Mach 3 for heated and unheated fuel cases. In this exemplary graph, payload fraction PF is assumed to be zero, the L/D ratio is 6, and empty mass fraction MF is assumed to be 0.50. Curve 900, representing the case of unheated fuel, depicts the specific impulse Iₛₚ for a pre-combustion fuel temperature T_{fuel} of 100° K. Curve 902, which represents the case heated fuel case, illustrates specific impulse Iₛₚ for a T_{fuel} of engine compressor exit temperature T₃. Additional curve 910 indicates the percentage of range improvement that results from pre-combustion fuel heating. For example, assuming the vehicle L/D ratio and MF remain constant, increasing fuel temperature from 100° K to temperature T₃ provides a range increase of approximately 15% at Mach 4.

In the normal course of operation, prior art jet engines provide compressor bleed air and auxiliary shaft power to both engine and airframe subsystems. Bleed air circulation and oil cooling (with bleed air) are the primary methods used for thermal management within the engine. Bleed air is also used by various subsystem of the aircraft. Conventional bleed air and auxiliary power draw energy away from the propulsive function of the engine and negatively impact fuel consumption. The disclosed PHC methods and systems allow inlet air to be compressed and cooled and supplied to both the engine and airframe components having bleed air needs. Normal shaft power drawn from the engine can be eliminated and supplied by the PHC system, improving the engine's efficiency. In high Mach number applications, the temperature around the engine becomes challenging for auxiliary equipment, and bleed air temperatures rise above useful levels. The disclosed PHC methods and systems allow auxiliary equipment to be removed from the engine and provide the engine with cooled bleed air for enhanced thermal management capability.

The disclosed PHC methods and systems can also be used to remove airframe heat. The compressed and cooled bleed air from the system can be passed through an airframe heat exchanger, providing heat removal for the aircraft. The warmed bleed air, still of relatively cool temperature, is then delivered to the engine.

In summary, the disclosed PHC methods and systems can improve the performance of a hydrogen-fueled jet engine by collecting aerothermal heat from inlet air and the airframe to heat fuel to be injected into the engine, which contributes to the heat of combustion driving the engine. Additionally, implementing the PHC methods and systems can simplify the design of a jet engine by removing the bleed and auxiliary power functions from the jet engine and replacing these functions with components of the PHC systems. By removing the bleed air circulation and auxiliary power demands from the jet engine, power losses in the jet engine associated with conventional methods for extraction of bleed air and auxiliary power are eliminated. The disclosed PHC methods and systems benefit both the engine and airframe by providing bleed air with higher cooling capacity. The disclosed PHC methods and systems can also supply significant auxiliary power.

A PHC system can include components for:
1. Compressing and cooling hot inlet bypass air from a jet engine installation or air from a freestream ram air collected by the airframe to meet engine and airframe needs for cool bleed air,
2. Pressurizing hydrogen (or other fuel) for engine injection,
3. Driving air compressors for bleed air pressurization,
4. Driving auxiliary powered devices, whether directly (e.g., via shaft motion) or indirectly (e.g., through electrical, pneumatic, hydraulic, or other form of power),
5. Heating fuel by cooling compressed air,
6. Dissipating heat from an airframe heat transfer loop.
7. Supplying bleed air and/or auxiliary power from the engine,
8. Collecting heat from the engine and/or airframe to heat the fuel, contributing to the heat of combustion delivered to the engine.

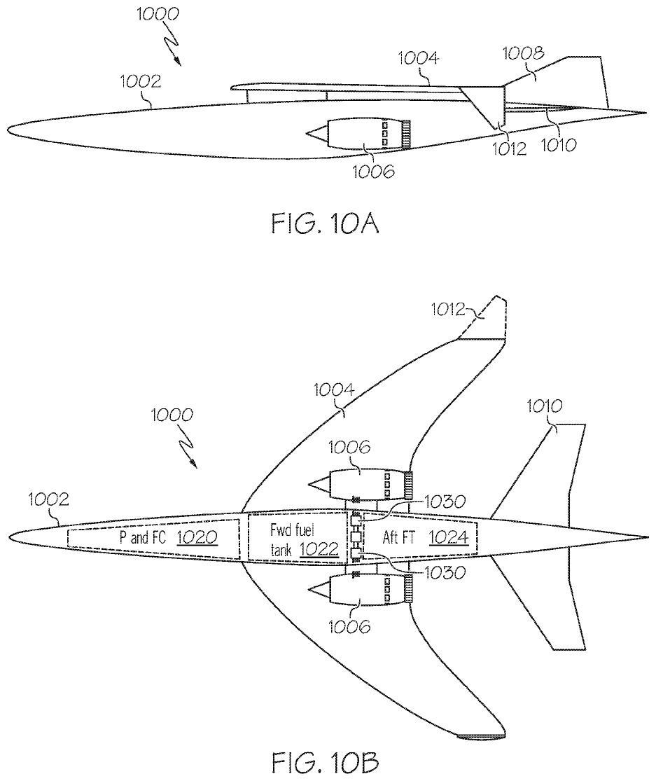

Referring now to FIGS. 10A-10B, there are depicted side elevation and bottom plan views of an exemplary supersonic aircraft 1000 in accordance with one or more embodiments. In some embodiments, supersonic aircraft 1000 is Mach-4 capable.

In this example, supersonic aircraft 1000 includes an airframe 1002, a wing assembly 1004, one or more jet engines 1006 (e.g., turboramjet engines), and an empennage including a vertical stabilizer 1008 and horizontal stabilizers 1010. As indicated, in some embodiments, wing assembly 1004 may include repositionable winglets 1012, which may be positioned angling downwardly with the respect to the general plane of wing assembly 1004 at cruising speeds and positioned extending along or upwardly with respect to the general plane of wing assembly 1004 at slower flight speeds. Airframe 1002 can house a payload and flight control section 1020, as well as forward and aft fuel tanks 1022 and 1024. Fuel tanks 1022 and 1024 are preferably located at or near the approximate center of gravity of supersonic aircraft 1000.

, FIG. 10B additionally illustrates an exemplary airframe installation of PHC components with respect to the fuel tanks and engines. Functionally, one or more PHC components can be interposed between the fuel tank(s) 1022 and/or 1024 and jet engines 1006 to pump and heat the fuel (e.g., cryogenic hydrogen) before delivery to jet engines 1006. In this example, airframe 1002 supports two PHC units 1030, where each PHC unit 1030 is dedicated to one of jet engines 1006 and is preferably coupled to accept fuel from either or both fuel tanks 1022 and 1024. Generally, a one-to-one association of a PHC unit 1030 to a jet engine 1006 or fuel tank 1022, 1024, if made, is an aircraft design choice rather than a requirement for a PHC installation. In the illustrated installation, each PHC unit 1030 receives inlet air from an associated jet engine 1006. In other embodiments, a PHC unit 1030 can receive inlet air from ports on the airframe 1002 and/or a jet engine 1006.

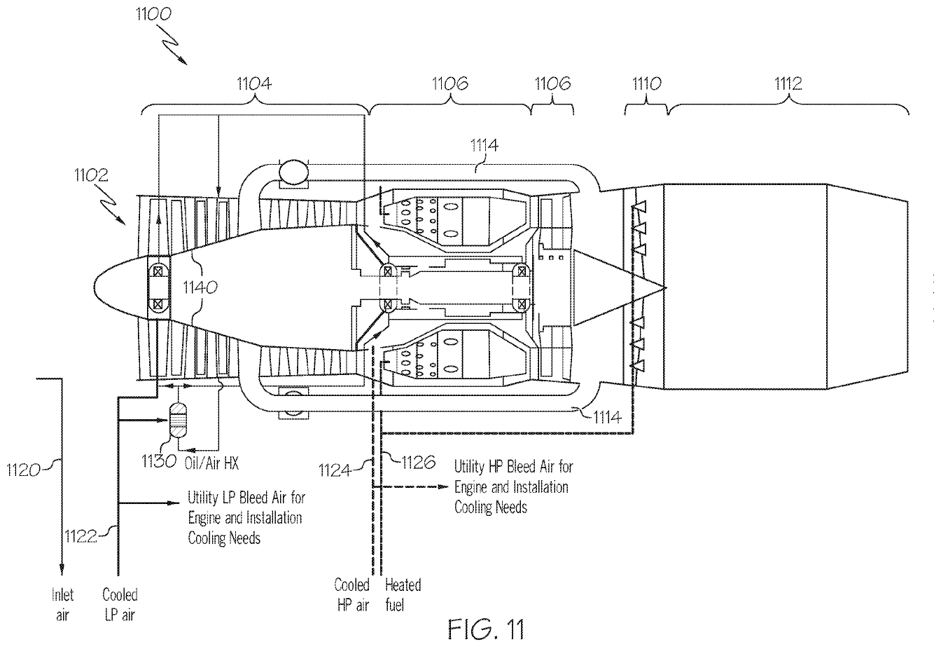

Referring now to FIG. 11, there is illustrated a section view of an exemplary jet engine 1100 suitable for use as a jet engine 1006 of a supersonic aircraft 1000 capable of sustained flight at speeds greater than Mach 2.5. Flight at such high Mach numbers presents challenging environments and performance demands that favor multi-cycle engine types like the turboramjet (turborocket) engine specifically illustrated in FIG. 11. It should be appreciated, however, that jet engine 1100 can alternatively be implemented as a turbojet, turbofan, ramjet, scramjet, turboshaft, turboexpander, or pulse detonation engine, or a multi-cycle variant of any of the preceding engines.

Jet engine 1100 has an inlet 1102 into which air is received, a compressor section 1104 that compresses the incoming air, a combustion section 1106 in which a mixture of compressed (i.e., high-pressure) air and fuel is burned, a turbine section 1108 coupled to the compressor section 1104 and rotated by the exhaust gasses produced by combustion section 1106, a rocket or re-heat burner section 1110, and an exhaust nozzle 1112 from which gases exit jet engine 1100. One or more bypasses 1114 provide fluid communication between compressor section 1104 and rocket or re-heat burner section 1110 to enable incoming air to selectively bypass combustion section 1106 (e.g., at high flight speeds).

FIG. 11 further illustrates exemplary fluid inputs and outputs that can be communicated between a PHC unit 1030 and a jet engine 1100. For example, jet engine 1100 may include an air inlet that provides atmospheric inlet air 1120 to PHC unit 1030. PHC unit 1030 may additionally provide to jet engine 1100 low-pressure (LP) air 1122, high-pressure (HP) air 1124, and heated gaseous (e.g., hydrogen) fuel 1126. LP air 1120 can be for utilized, for example, for engine oil cooling in an oil/air heat exchanger 1130, for engine cooling in compressor section 1104, and for utility bleed air for engine and installation cooling needs. Cooled HP air 1124 can be utilized in jet engine 1100, for example, for pressurization and cooling of combustion section 1106 (i.e., the high-pressure engine section) and utility bleed air for engine and installation cooling needs. The heated gaseous fuel is supplied to engine 1100 for combustion in the combustors of combustion section 1106 and re-heat burners or rocket section 1110.

A PHC unit 1030 provides many benefits to high-Mach number multi-cycle jet engines, such as exemplary jet engine 1100 in terms of cooling, auxiliary power relocation off the engine, and fuel heating. In the state-of-the-art, several high-Mach number multi-cycle jet engines exist, but these jet engines typically do not use cryogenic and high vapor pressure fuels, such as hydrogen, methane, and propane. The PHC techniques disclosed herein facilitate use of cryogenic and high vapor pressure fuels because the PHC unit vaporizes, pressurizes, and heats the fuel for delivery to the jet engine. All jet engine types can benefit from fuel heating, air pressurization, cooling, and off-engine auxiliary power generation. Many of these jet engines have similar core compressor-turbine configuration and manage bleed-air, oil, and fuel in similar ways. Various jet engine types have different configurations of compressors, turbines, and shafts consistent with their different propulsive designs and application requirements. A PHC unit can be coupled to all jet engine types in similar ways, but with variations consistent with the internal differences between the engine types and their differing application requirements.

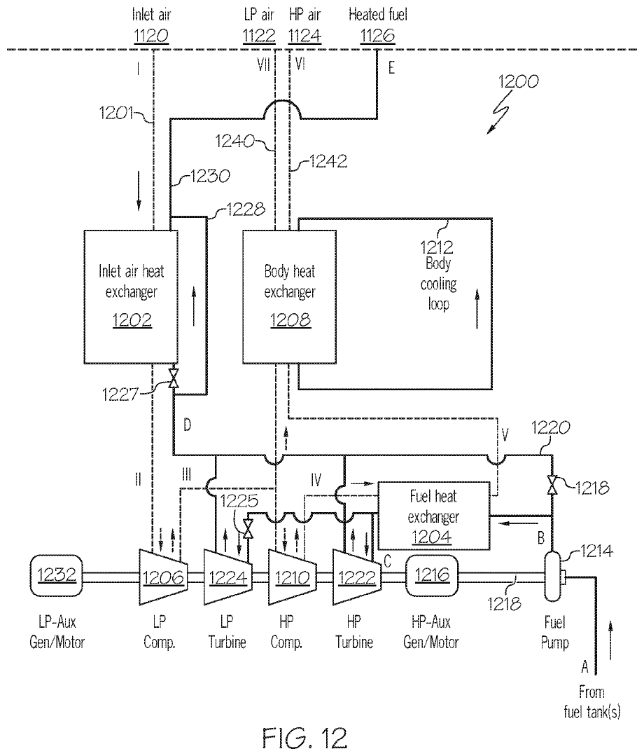

Those skilled in the art will appreciate that, in implementation, an engine installation will include all features and functions required to integrate the engine to an airframe. An exemplary installation, depending upon the requirements of the aircraft design, includes: the engine inlet, nozzle, cowling enclosure, the structural and aerodynamic mount for the engine, flow paths for cooling needs, inlet flow control, nozzle flow control, and interfaces for the control of fuel, bleed air, electrical power and more. FIG. 11 principally illustrates the engine and fluidic inputs and outputs between the engine and the PHC unit, an embodiment of which is depicted in greater detail in FIG. 12. FIG. 11 does not illustrate in detail general aircraft features like the inlet, nozzle, and other important structural and aerodynamic features because they are relatively independent of the installation of the PHC unit 1030 to an engine. Conventional installation features in the state-of-the-art include auxiliary electrical, hydraulic, and shaft power, and sources of bleed air coming from the engine. The PHC unit can be a source of auxiliary power and bleed air that augments or replaces such features on the engine in conventional installations.

Referring now to FIG. 12, there is depicted an exemplary propulsive heating and cooling (PHC) system 1200 in accordance with one or more embodiments. PHC system 1200 of FIG. 12 can be utilized, for example, to implement one of the PHC systems 1030 of the supersonic aircraft 1000 depicted in FIG. 10.

PHC unit 1200 includes an air flow path (illustrated in single solid line) and a fuel flow path (illustrated with triple lines) that thermally interact with each other via one or more heat exchangers (HX), including, for example, an inlet air heat exchanger 1202 and a fuel heat exchanger 1204. The present application appreciates that fuel leakage from heat exchangers 1202, 1204 would pose a flammability risk to PHC unit 1200 and the engine and that any such leak that would be particularly dangerous. Heat exchangers 1202, 1204 are therefore preferably designed to prevent air/fuel mixing.

In the illustrated embodiment, the air flow path of PHC unit 1200 includes an inlet air conduit 1201 that receives freestream ram inlet air 1120 taken from near engine inlet 1102. The ram inlet air is collected at near stagnation pressure and at the prevailing temperature conditions of flight. At high speeds, the kinetic energy of flight results in air with significant total pressure and temperature, which PHC unit 1200 utilizes as a heat source. Heat for vaporizing and heating fuel can thus extracted from the cooling of inlet air. Inlet air 1120 passes from inlet air conduit 1201 through inlet air heat exchanger 1202 to cool the inlet air 1120 and heat the fuel (e.g., hydrogen). The cooled inlet air passes from inlet air heat exchanger 1202 to a LP compressor 1206, which is coupled (along with a LP turbine 1224) to a LP-auxiliary generator/motor 1232 via a rotatable LP shaft 1234. LP compressor 1206 performs an initial compression to obtain LP air, which is passed through a body heat exchanger 1208 to the jet engine 1100 as LP air 1122 via air conduit 1240. Some of the LP air produced by LP compressor 1206 can be further compressed by a HP compressor 1210 to obtain HP air. The HP air is passed through fuel heat exchanger 1204, which heats the fuel and cools the HP air. HP air exiting fuel heat exchanger 1204 flows through an optional body heat exchanger 1208 and from body heat exchanger 1208 via air conduit 1242 to jet engine 1100 to supply cooled HP air 1124. An optional body cooling loop 1212 can be implemented for some aircraft applications. Body cooling loop 1212 circulates a fluid that transports unwanted heat from the aircraft body (e.g., airframe 1002 and/or wing assembly 1004) to body heat exchanger 1208.

In the embodiment of jet engine 1100 of FIG. 11, LP air 1122 is routed to pressurize the low-pressure compression section 1104 of jet engine 1100. In conventional engines, low pressure air comes from a LP bleed port 1140 disposed in one of the early stages of the compression section 1104. During engine startup and low air flow operation, conventional LP bleed port 1140 can perform its normal function. As PHC unit 1200 comes up to operating conditions, the pressure of LP air 1122 equals or slightly exceeds that of the air supplied of LP bleed port 1140 and assumes the functions of cooling and pressurizing the compression section 1104 of the engine core. As noted above, a portion of LP air 1122 can also provide cooling to the engine oil via oil/air heat-exchanger 1130. Another portion of LP air 1122 can also supply the LP bleed air that provides cooling, pressure, and air flow capacity to other components of the overall engine installation.

Cooled HP air 1124 delivered to jet engine 1100 by PHC unit 1200 can similarly be utilized to pressurize and to cool the high-pressure section of the engine (i.e., combustion section 1106). Cooled HP air 1124 can additionally provide utility HP bleed air for cooling, pressure, and flow capability for the overall engine installation, including, in the embodiments, providing cooling capability to the turbine nozzle and blades.

In the fuel flow path, liquid hydrogen stored in one or more fuel tanks (i.e., fuel tank 1022 and/or 1024 in FIG. 10) enters a fuel pump 1214, which, along with a HP compressor 1210 and HP turbine 1222, is coupled to a HP-auxiliary generator/motor 1216 via a rotatable HP shaft 1218. Fuel pump 1214 is configured to pump fuel, preferably in cryogenic liquid phase, from fuel tank 1022 and/or 1024 responsive to rotation of HP shaft 1218. The fuel is pressurized by fuel pump 1214.

Fuel exiting fuel pump 1214 vaporizes, thus changing from a liquid to a gaseous state. Some of the fuel can selectively be passed through valve 1218 to a primary fuel supply conduit 1220. Other fuel passes through fuel heat exchanger 1204, heating the fuel with the heat of the HP air in the air flow path, as that heat is available. Fuel exiting fuel heat exchanger 1204 is pressurized by a HP turbine 1222 and selectively further pressurized by a LP turbine 1224, depending on the setting of valve 1225, which controls the fraction (if any) of fuel passing through LP turbine 1224. Fuel exiting HP turbine 1222 and LP turbine 1224 is also passed to primary fuel supply conduit 1220. The setting of valve 1227 determines what fraction of the fuel supplied to the associated jet engine is further heated by inlet air heat exchanger 1202 and what fraction of the fuel supplied to the associated jet engine is permitted to bypass inlet air heat exchanger 1202 and instead flow through bypass conduit 1228. Fuel exiting inlet air heat exchanger 1202 and/or bypass conduit 1228 is supplied, via fuel conduit 1230, to the associated jet engine as heated fuel 1126. The fuel flow path thus delivers pressurized high-temperature fuel to the associated jet engine for combustion. As noted above, fuel delivered to a jet engine 1100 as illustrated in FIG. 11 can be consumed in the combustors of the engine's combustion section 1106 and/or in the re-heat burner section 1110. The fuel flow path can also be utilized to allow expansion of fuel in the gas phase to produce work to power fuel pump 1214 and supply power for the auxiliary power needs of the aircraft via HP auxiliary generator/motor 1216.

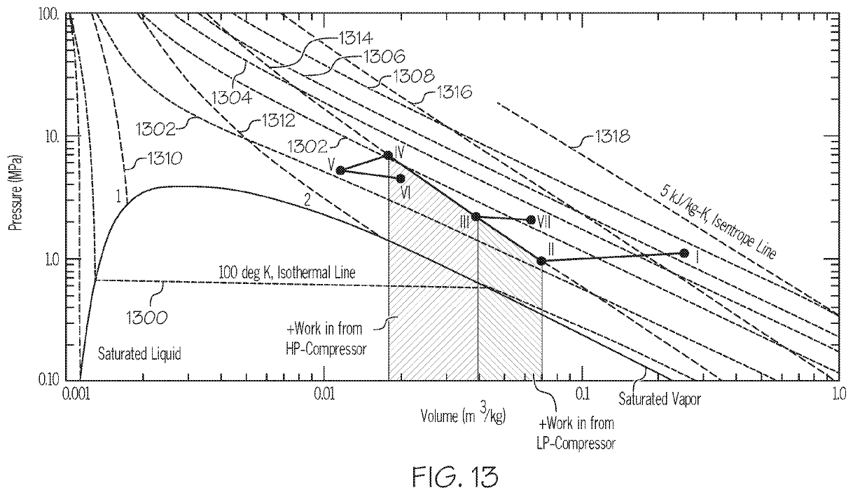

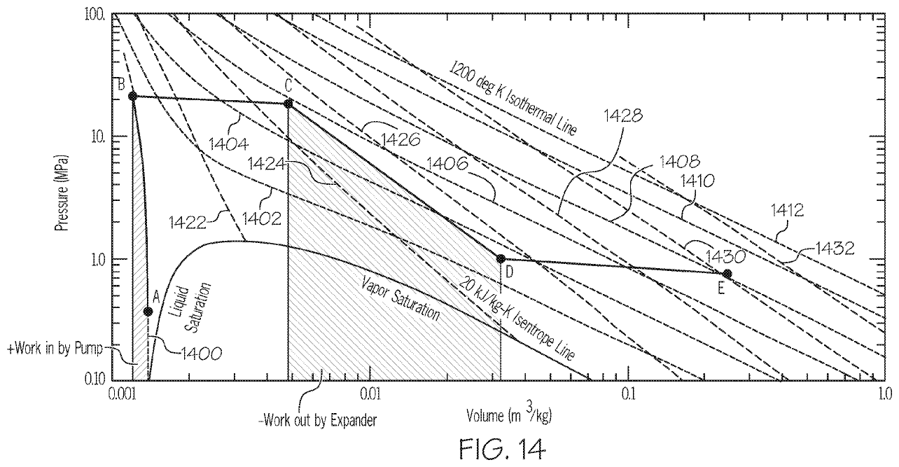

With reference now to FIGS. 13 and 14, there are respectively illustrated a Pressure-Volume (P-V) thermodynamic chart of the air flow path and a P-V chart of the fuel flow path. Both thermodynamic charts employ logarithmic scales and illustrate a notional design point of a Mach 4 propulsion system.

Referring now to FIG. 13, curves 1300, 1302, 1304, 1306, and 1308 respectively represent isothermal lines for temperatures of 100° K, 200° K, 400° K, 600° K, 800° K, and 1200° K. Curves 1310, 1312, 1314, 1316, and 1318 additionally respectively represent isentrope lines for 1, 2, 3, 4, and 5 KJ/kg-K. The states of air denoted by capital Roman numerals in FIG. 13 correspond to locations in PHC unit 1200 depicted in FIG. 12.

Inlet air 1120 enters inlet air conduit 1201 at state I near flight stagnation temperatures and pressures. Air flowing into the inlet air heat exchanger 1202 is cooled from state I to state II by the fuel flow. In at least some examples, inlet air heat exchanger 1202 includes features beyond those supporting heat exchange. For example, inlet air heat exchanger 1202 preferably includes moisture removal capability due to water condensation of atmospheric air upon cooling. The cooling capacity of hydrogen and other similar cryogenic fuels is high. Heat exchange is preferably controlled to guard against water icing and air freezing. In the illustrated embodiment, valve 1227 controls flow of fuel through inlet air heat exchanger 1202 and thus heat exchange between the air and fuel flow paths.

Air at state II enters LP compressor 1206 and is pressurized to state III. A portion of the air flow can be directed through body heat exchanger 1208 to absorb a portion of the heat delivered by body cooling loop 1212. This air flow is delivered to the engine at state VII as LP air 1122. The other portion of air coming from the LP compressor 1206 enters HP compressor 1210 and is pressurized to state IV. HP compressor 1210 pressurizes the air and increases its temperature to enable the HP air to warm the fuel via fuel heat exchanger 1204. After fuel heat exchanger 1204, the HP air flow is in state V. Fuel heat exchanger 1204 has an associated valve 1218 controlling fuel bypass of fuel heat exchanger 1204. This flow control is performed, in part, to prevent air freezing and also to control overall power generation in the fuel flow path. After the fuel heat exchanger 1204, HP air flow is directed to body heat exchanger 1208 to absorb heat from body cooling loop 1212. Upon exiting body heat exchanger 1208, the HP air flow is in state VI and delivered to the engine as cooled HP air 1124.

Referring now to FIG. 14, curves 1400, 1402, 1404, 1406, 1408, 1410, and 1412 respectively represent isothermal lines for temperatures of 20° K, 50° K, 100° K, 200° K, 400° K, 800° K, and 1200° K. Curves 1420, 1422, 1424, 1426, 1428, 1430, and 1432 additionally respectively represent isentrope lines for 0, 10, 20, 30, 40, 50, and 60 KJ/kg-K. The states of fuel denoted by capital letters in FIG. 14 correspond to locations in PHC unit 1200 depicted in FIG. 12.

In FIG. 14, the cryogenic fuel (in this case, hydrogen) in fuel tanks 1022, 1024 is initially in liquid state, as shown at point A. The liquid fuel enters fuel pump 1214, which pressurizes the liquid fuel to state B. State B is well above the critical pressure of the fuel and the target delivery pressure of the fuel to the engine. Fuel flow is then directed through fuel heat exchanger 1204, heating the fuel to state C. In fuel heat exchanger 1204, heat is absorbed from the HP air flow. While initially hot external air is cooled during passage through inlet heat exchanger 1202, the air is warmed by adiabatic compression in LP compressor 1206 and HP compressor 1210. The warming of the air by compressors 1206, 1210 facilitates improved heat transfer in fuel heat exchanger 1204 with a larger temperature differential between the fuel and air. The vaporization and warming of fuel from state B to C provides the opportunity for the fuel, as a working fluid, to provide shaft work (pressure-volume work) by its expansion.

After fuel heat exchanger 1204, the fuel is expanded by HP turbine 1222 and LP turbine 1224. HP turbine 1222 is arranged to generate shaft power for fuel pump 1214, HP compressor 1210, and the HP auxiliary generator/motor 1216. LP turbine 1224 is arranged to generate shaft power for LP compressor 1206 and LP auxiliary generator/motor 1232. These turbines not only provide necessary power for the PHC pumps and compressors, but also provide auxiliary power for the engine and airframe. As indicated, both LP auxiliary generator/motor 1232 and HP auxiliary generator/motor 1216 can also be motors that can be used for starting and motoring operations. Note that, in the air P-V thermodynamic graph given in FIG. 13, the area under the compression portion of the cycle (i.e., the area below the line segment linking points II and IV) represents the work needed to drive the compressors. In the fuel P-V thermodynamic graph given in FIG. 14, the area representing the work available from the expansion of the fuel (e.g., hydrogen) is the area under the cycle portion for the expander (i.e., HP turbine 1222), which is bounded by the line segment linking points C and D. The work required to drive fuel pump 1214 is also shown in FIG. 14 (i.e., the area below the curve linking points A and B). As an approximation, the area of PV work for the compressors and pump is slightly less than the area of work for the expander.

PHC unit 1200 is preferably sized so PV work of the heated fuel is at least equal to the work required by fuel pump 1214, compressors 1206 and 1210, and auxiliary generators 1216 and 1232. A level of control is required to balance turbine power to the demand of fuel pump 1214, compressors 1206 and 1210, and auxiliary generators 1216 and 1232. This control is achieved by regulating the fuel flow through fuel heat exchanger 1204 with bypass valve 1218. In the embodiment of FIG. 12, each of power shafts 1234 and 1218 has its own respective turbine, namely, LP turbine 1224 and HP turbine 1222. Power sharing between shafts 1234 and 1218 is regulated by control valve 1225, which controls fuel flow to LP turbines 1224.

After expanding fuel from state C to state D, the outlet flows of HP turbine 1222 and LP turbine 1206 are combined to equilibrate with the bypass flow, and the combined flow is delivered to inlet air heat exchanger 1202. Hot and compressed air from flight stagnation conditions heat the fuel flow from state D to E. The pressurized, heated fuel 1126 is then delivered to the engine for combustion. As stated previously, the flow of fuel through the inlet air heat exchanger 1202 is preferably controlled by bypass valve 1227 to avoid freezing of air or water ice.

Those skilled in the art will appreciate that following HP turbine 1222, the fuel can be heated again and expanded again to obtain additional auxiliary power. The number and sizes of air compressor stages and fuel expanders can vary between embodiments to meet the demands for pressurized air supply, airframe cooling, and auxiliary power.

Some of the exemplary embodiments described herein use cryogenic hydrogen as fuel. Other cryogenic fuels such as liquid methane, propane, mixtures of hydrogen and other high-vapor pressure fuel, or slush cryogenic fuel may also be used.

The exemplary engine embodiment given in FIG. 11 is a turboramjet engine. The disclosed inventions can also be applied to other engine types, such as, for example, turbojet, turbofan, turboshaft, ramjet, scramjet, internal combustion, and pulse detonating type engines, as well as expander turbine and multi-cycle combinations of jet engines.

The exemplary PHC unit 1200 depicted in FIG. 12 uses expansion of heated fuel to provide shaft power for the fuel pump, air compressors, and auxiliary equipment. Other methods of generating shaft power are possible, such as, for example, power take-off from the engine or from aircraft auxiliary power units (APUs) or devices.

The exemplary PHC unit 1200 depicted in FIG. 12 uses two shafts, a LP shaft and a HP shaft, to distribute turbine power. Other embodiments can include a single shaft or other combinations of shafts.

The exemplary PHC unit 1200 depicted in FIG. 12 uses a shaft to distribute turbine power to a fuel pump, compressors, and/or other auxiliary powered devices. Those skilled in the art will appreciate that other methods for power transfer can alternatively or additionally be employed. For example, in some embodiments, turbine spun generators can be utilized to supply electrical power to pump(s) and compressor(s). Alternatively or additionally, power can be transferred to auxiliary devices pneumatically or hydraulically.

The exemplary PHC unit 1200 depicted in FIG. 12 employs pumps, compressors, and turbines of the turbo-flow type. In other embodiments, positive-displacement type devices can alternatively or additionally be utilized. Positive-displacement pumps for the fuel may have advantages in control and cavitation tolerance over turbopump devices. In order to transfer power, the selected embodiments of the pump, compressor, expander, and power device may dictate that a shaft moves in a preferred manner, such as rotation, translation, or a combination of rotation and translation.

The PHC techniques disclosed herein also have application to marine propulsion and stationary power generation that heat fuel and have available heat sources such as water, air, or geothermal reservoirs of useable heat.

As has been described, in one or more embodiments, an apparatus warms fuel prior to combustion in a jet engine of an aircraft and supplies cooled bleed air to the aircraft. The apparatus includes a fuel flow path configured to supply fuel to the jet engine for combustion, an air flow path including an inlet air conduit configured to receive external freestream ram air, and an inlet air heat exchanger configured to transfer heat from the inlet air conduit to gaseous state fuel in the fuel flow path prior to supply of the fuel to the jet engine. The inlet air conduit is a first air conduit and the air flow path includes a second air conduit that directs cooled air after the inlet air heat exchanger to the aircraft.

In some embodiments, the fuel flow path includes a bypass conduit through which fuel in the fuel flow path can bypass the inlet air heat exchanger and a control valve configured to selectively control a fraction of the fuel supplied to the jet engine that is permitted to pass through the bypass conduit and bypass the inlet air heat exchanger.

In some embodiments, the apparatus further comprises at least one compressor that compresses the inlet air following heat transfer in the inlet air heat exchanger to obtain cooled and pressurized air supplied by the air flow path to the aircraft. In some embodiments, the at least one compressor produces at least two pressurized air supplies of differing pressures that are supplied to the jet engine.

In some embodiments, the apparatus includes a fuel heat exchanger in the fuel flow path before the inlet air heat exchanger that is configured to transfer heat from the cooled and pressurized air to the fuel in the fuel flow path. In some embodiments, the apparatus includes a control valve configured to selectively control a fraction of the fuel in the fuel flow path that is permitted to pass through the fuel heat exchanger.

In some embodiments, the apparatus includes at least one expander driven by expansion of the fuel and a drive shaft coupled to the expander. In some embodiments, the apparatus includes a fuel pump driven by the drive shaft to pump the fuel into the fuel flow path. In some embodiments, the apparatus includes multiple expanders and a valve controlling a fraction of the fuel passing through one of the expanders.

In some embodiments, the apparatus includes an auxiliary powered device powered by the shaft. In some embodiments, the apparatus includes a compressor coupled to a shaft, where the compressor is configured to compress the inlet air following heat transfer in the inlet air heat exchanger to obtain pressurized air supplied to the aircraft.

In some embodiments, the apparatus includes a body heat exchanger configured to transfer heat from a body cooling loop of the aircraft to the air flow path.

In some embodiments, the apparatus includes a power shaft, a compressor coupled to the power shaft and configured to compress the inlet air to obtain pressurized air supplied to the aircraft, and a expander coupled to power the power shaft and driven by expansion of the fuel in the fuel flow path. The work performed by the expander is at least equal to the work performed by the compressor.

In some embodiments, the apparatus forms a portion of an aircraft including an airframe, a wing assembly coupled to the airframe, an empennage coupled to the airframe, at least one jet engine coupled to the airframe, a fuel tank configured to hold cryogenic fuel in a liquid state, and a fuel pump coupled to the fuel tank. The apparatus can be coupled by the fuel flow path to the fuel pump and the air flow path to the jet engine.

While the present invention has been particularly shown as described with reference to one or more preferred embodiments, it will be understood by those skilled in the art that various changes in form and detail may be made therein without departing from the spirit and scope of the invention. The figures described above and the written description of specific structures and functions are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms and that multiple of the disclosed embodiments can be combined. The term “exemplary” is defined as meaning one example of the described method, step, element, or system rather than the only, preferred, or best example. Lastly, the use of a singular term, such as, but not limited to, “a” is not intended as limiting of the number of items.

What is claimed is:

1. An apparatus for warming fuel prior to combustion in a jet engine of an aircraft and supplying cooled bleed air to the aircraft, the apparatus comprising:
a fuel flow path configured to supply fuel to a jet engine for combustion;
an air flow path including an inlet air conduit configured to receive external freestream ram air; and
an inlet air heat exchanger configured to transfer heat from the inlet air conduit to fuel in a gaseous state in the fuel flow path prior to supply of the fuel to the jet engine;
wherein the inlet air conduit is a first air conduit and the air flow path includes a second air conduit that directs cooled air after the inlet air heat exchanger to the aircraft.

2. The apparatus of claim 1, wherein:
the fuel flow path includes a bypass conduit through which fuel in the fuel flow path can bypass the inlet air heat exchanger; and
a control valve configured to selectively control a fraction of the fuel supplied to the jet engine that is permitted to pass through the bypass conduit and bypass the inlet air heat exchanger.

3. The apparatus of claim 1, further comprising at least one compressor that compresses the inlet air following heat transfer in the inlet air heat exchanger to obtain cooled and pressurized air, wherein the air flow path is configured to supply the cooled pressurized air to the aircraft.

4. The apparatus of claim 3, wherein:
the at least one compressor produces at least two pressurized air supplies of differing pressures; and
the air flow path is configured to provide the at least two pressurized air supplies to the jet engine.

5. The apparatus of claim 3, further comprising:
a fuel heat exchanger in the fuel flow path before the inlet air heat exchanger configured to transfer heat from the cooled and pressurized air to the fuel in the fuel flow path.

6. The apparatus of claim 5, further comprising a control valve configured to selectively control a fraction of the fuel in the fuel flow path that is permitted to pass through the fuel heat exchanger.

7. The apparatus of claim 1, further comprising:
at least one expander driven by expansion of the fuel; and
a power shaft coupled to the expander.

8. The apparatus of claim 7, further comprising a fuel pump powered based on motion of the power shaft to pump the fuel into the fuel flow path.

9. The apparatus of claim 7, further comprising an auxiliary powered device powered based on motion of the power shaft.

10. The apparatus of claim 7, wherein:
the at least one expander includes a first expander;
the power shaft is a first shaft; and
the apparatus further includes:
a second shaft;
a second expander driven by expansion of the fuel in the fuel flow path, wherein the second expander is coupled to and drives the second shaft; and
a valve controlling a fraction of the fuel passing through the second expander.

11. The apparatus of claim 10, further comprising:
a compressor powered based on motion of a shaft among the first and second shafts, wherein the compressor is configured to compress the inlet air following heat transfer in the inlet air heat exchanger to obtain pressurized air, and wherein the air flow path is configured to supply the pressurized air to the aircraft.

12. The apparatus of claim 1, further comprising a body heat exchanger configured to transfer heat from a body cooling loop of the aircraft to the air flow path.

13. The apparatus of claim 1, further comprising:
a power shaft;
a compressor powered by the power shaft and configured to compress the inlet air to obtain pressurized air, wherein the air flow path is configured to supply the pressurized air to the aircraft; and
an expander coupled to power the power shaft, wherein the expander is driven by expansion of the fuel in fuel flow path, wherein the work performed by the expander is at least equal to the work performed by the compressor.

14. An aircraft, comprising:
an airframe;
a wing assembly coupled to the airframe;
at least one jet engine coupled to the airframe;
a fuel tank configured to hold cryogenic fuel in a liquid state; and
a fuel pump coupled to the fuel tank; and
the apparatus of claim 1 coupled by the fuel flow path to the fuel pump and the air flow path to the jet engine.

15. A method of warming fuel prior to combustion and providing cooled air in an aircraft, the method comprising:
supplying, via a fuel flow path, fuel in a gaseous state to a jet engine for combustion;
receiving, via an inlet air conduit of an air flow path, freestream ram air external to the aircraft; and
transferring heat, by an inlet air heat exchanger, from the inlet air to fuel in the fuel flow path prior to supply of the fuel to the jet engine; and
supplying cooled air obtained after the inlet air heat exchanger to the aircraft.

16. The method of claim 15, wherein:
the fuel flow path includes a bypass conduit through which fuel in the fuel flow path can bypass the inlet air heat exchanger; and
the method includes controlling, utilizing a control valve, a fraction of the fuel supplied to the jet engine that is permitted to pass through the bypass conduit and bypass the inlet air heat exchanger.

17. The method of claim 15, further comprising:
compressing, by at least one compressor, the inlet air following heat transfer in the inlet air heat exchanger to obtain pressurized air; and
supplying the pressurized air to aircraft via the air flow path.

18. The method of claim 17, wherein:
the compressing includes producing at least two pressurized air supplies of differing pressures; and
the supplying includes supplying the at least two pressurized air supplies to the aircraft.

19. The method of claim 18, further comprising:
transferring heat, by a fuel heat exchanger, from the pressurized air to the fuel in the fuel flow path.

20. The method of claim 19, further comprising:
controlling, by a control valve, a fraction of the fuel in the fuel flow path that is permitted to pass through the fuel heat exchanger.

21. The method of claim 16, further comprising:
driving at least one turbine by expansion of the fuel in the fuel flow path; and
driving a power shaft by the expander.

22. The method of claim 21, further comprising:
pumping fuel, by a fuel pump powered based on motion of the power shaft, into the fuel flow path.

23. The method of claim 21, further comprising:
powering an auxiliary powered device based on motion of the power shaft.

24. The method of claim 21, wherein:
the at least one turbine includes a first turbine and a second turbine;
the power shaft is a first shaft; and
the method further includes:
driving a second turbine by expansion of the fuel in the fuel flow path;
powering a second shaft by the second turbine; and
controlling a fraction of the fuel passing through the second turbine by a valve.

25. The method of claim 24, further comprising:
compressing, by a compressor coupled to a shaft among the first and second shafts, the inlet air following heat transfer in the inlet air heat exchanger to obtain pressurized air; and
supplying the pressurized air to the jet engine by the air flow path.

26. The method of claim 15, further comprising:
transferring heat, by a body heat exchanger, from a body cooling loop of the aircraft to the air flow path.

27. The method of claim 15, further comprising:
powering, by expansion of the fuel in the fuel flow path, a turbine coupled to a power shaft; and
compressing the inlet air, by a compressor powered based on motion of the power shaft, to obtain pressurized air supplied to the jet engine via the air flow path;
wherein the work performed by the turbine is at least equal to the work performed by the compressor.
